(19) United States
(12) Patent Application Publication
(10) Pub. No.: US 2010/0314510 A1
(43) Pub. Date: Dec. 16, 2010

(54) ADJUSTABLE VEHICLE SUPPORT STAND

(76) Inventors: David A. Munn, Dublin, OH (US); Brian T. Walters, Delaware, OH (US)

Correspondence Address: ULMER & BERNE, LLP;ATTN: DIANE BELL, 600 VINE STREET, SUITE 2800, CINCINNATI, OH, 45202, US

(21) Appl. No.: 12/482,097

(22) Filed: Jun. 10, 2009

(51) Int. Cl. B60S 9/08; F16M 11/26; B60S 9/04

(52) U.S. Cl. 248/125.8; 254/424; 254/418

(57) ABSTRACT

An adjustable vehicle support stand is provided that includes a base, a lower collar secured to the base, a rod, an upper collar and a plate secured to the upper collar. The plate is configured for attachment to a wheel hub of a vehicle. The rod includes a lower portion and an upper portion that are threadably engaged with the lower and upper collars, respectively. One of the lower and upper portions of the rod includes a plurality of left-hand external threads and the other of the lower and upper portions of the rod includes a plurality of right-hand external threads. The rod also includes a torquing portion that separates the lower and upper portions of the rod and that is configured to facilitate rotation of the rod. The plate is vertically movable relative to the base in response to rotation of the rod.

### TECHNICAL FIELD

The invention relates generally to a support stand, and more particularly to an adjustable vehicle support stand.

### BACKGROUND

Various measurements of a vehicle suspension can be achieved while the vehicle's wheels are installed by changing the air pressure within each tire until each vehicle axle reaches a desired height relative to a support surface upon which the wheels rest. Changes in the air pressure within the tires, (e.g., due to temperature changes), can result in undesirable changes in the height of the axles relative to the support surface. Also, in some instances the wheel rims can complicate obtaining the desired suspension measurements. For example, the rear wheel rims on an all terrain vehicle having independent rear suspension can prevent easy access to the rear knuckles, making the measurement of the independent rear suspension difficult, which can increase the time and cost associated with the measurements.

### SUMMARY

According to one embodiment, an adjustable vehicle support stand is provided that includes a base, a lower collar, a rod, an upper collar and a plate. The lower collar is secured to the base. The rod is threadably engaged with the lower collar and the upper collar. The plate is secured to the upper collar and extends upwardly from the upper collar. The plate is configured for attachment to a wheel hub of a vehicle. The rod includes a lower portion, an upper portion and a torquing portion separating the lower portion and the upper portion. The torquing portion is configured to facilitate rotation of the rod. The lower portion of the rod is threadably engaged with the lower collar and the upper portion of the rod is threadably engaged with the upper collar. One of the lower portion of the rod and the upper portion of the rod comprises a plurality of left-hand external threads and the other of the lower portion of the rod and the upper portion of the rod comprises a plurality of right-hand external threads. The plate is vertically movable relative to the base in response to rotation of the rod.

According to another embodiment, a method of vertically positioning a vehicle to measure a suspension of the vehicle is provided. The vehicle includes at least one rotatable wheel hub. The method includes providing an adjustable vehicle support stand. The stand includes a base, a lower collar secured to the base, a rod having a lower portion, an upper portion and a torquing portion separating the lower portion and the upper portion. The stand further includes an upper collar and a plate secured to the upper collar. The lower portion of the rod is threadably engaged with the lower collar and the upper portion of the rod is threadably engaged with the upper collar. The method also includes positioning the base on a support surface. The method further includes mounting the plate on the wheel hub and rotating the rod so that the plate and the wheel hub move vertically relative to the base and the wheel hub is spaced from the support surface by a predetermined vertical distance.

### BRIEF DESCRIPTION OF THE DRAWINGS

Various embodiments according to the inventive principles will become better understood with regard to the following description, appended claims and accompanying drawings wherein:

FIG. 1 is a side elevation view of a vehicle;

FIG. 2 is a side elevation view of the vehicle shown in FIG. 1, with the vehicle's wheels removed and with the vehicle supported by a plurality of adjustable vehicle support stands according to one embodiment;

FIG. 3 is an exploded, perspective view of one of the adjustable vehicle support stands shown in FIG. 2; and

FIG. 4 is an elevation view of the adjustable vehicle support stand shown In FIG. 3, with the adjustable vehicle support stand in an assembled condition.

### DETAILED DESCRIPTION

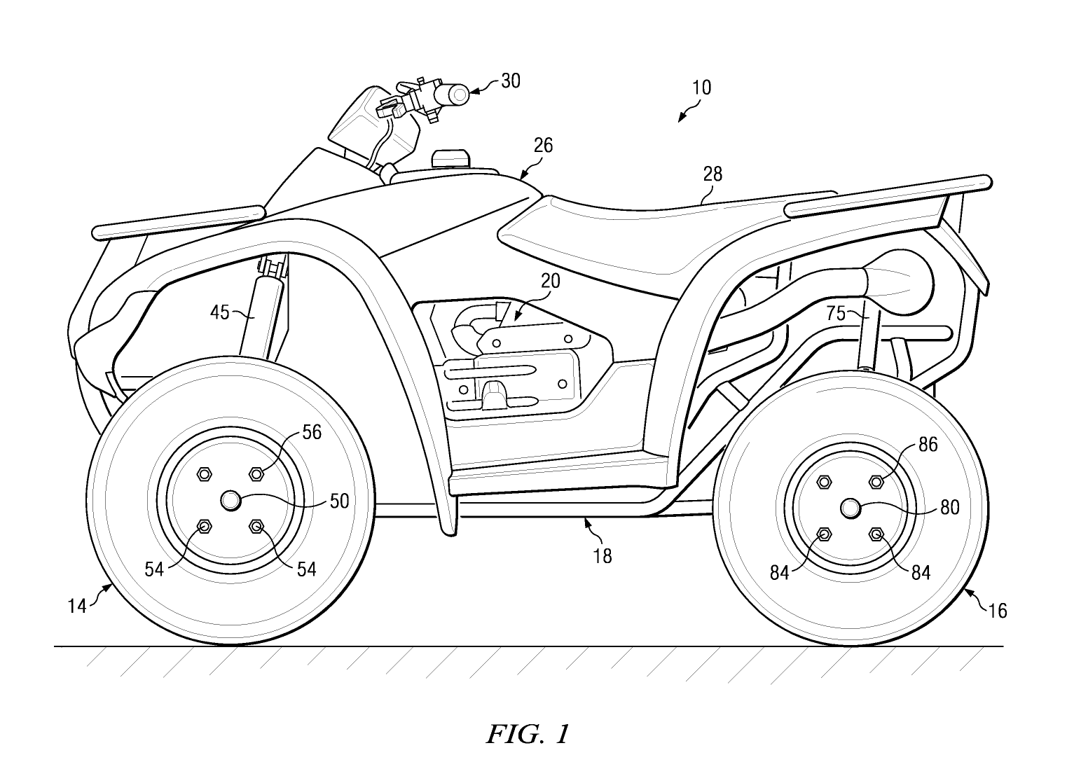

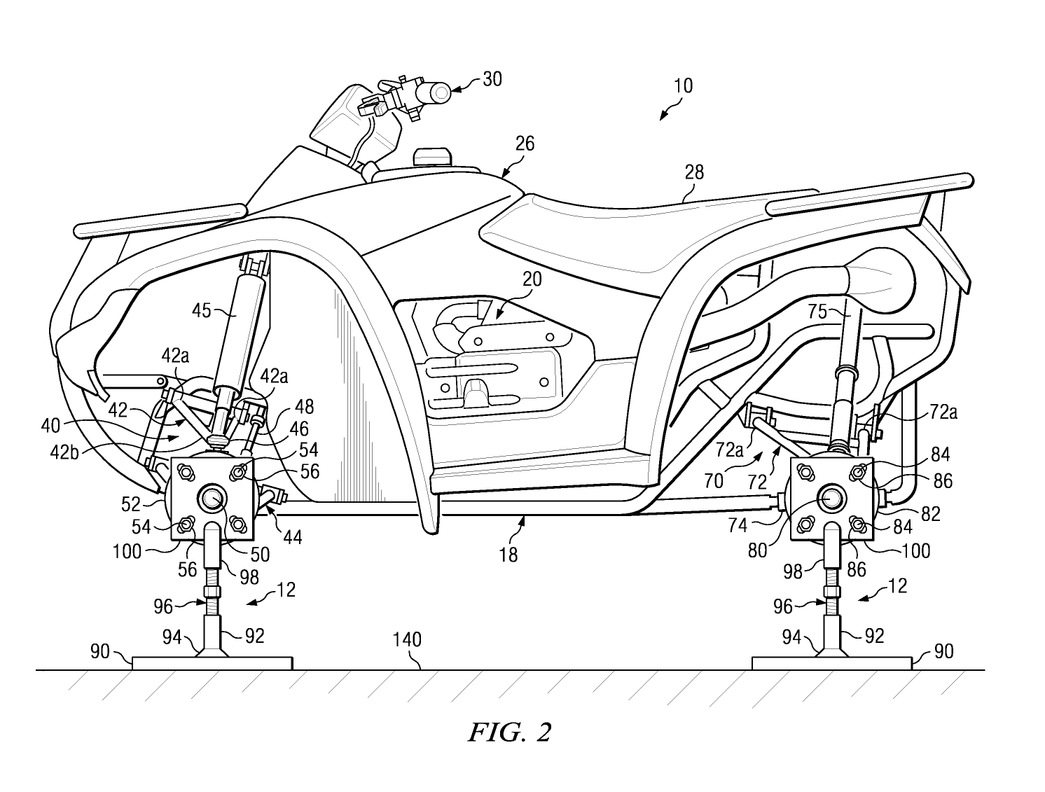

Referring to the drawings, wherein like numbers indicate the same or corresponding elements throughout the views, FIG. 1 illustrates a vehicle 10 and FIG. 2 illustrates vehicle 10 with the vehicle's wheels removed, and with vehicle 10 supported by a plurality of adjustable vehicle support stands 12 according to one embodiment. The adjustable vehicle support stand 12 can be used with a saddle-type vehicle such as vehicle 10, which is shown to be an all terrain vehicle (ATV) in FIGS. 1 and 2, or with a variety of other land, water, or other vehicles.

Vehicle 10 can include two rotatable front wheels 14 (one shown) and two rotatable rear wheels 16 (one shown). The front wheels 14 and rear wheels 16 can be suspended from a frame 18 and can be rotatable relative to frame 18. Vehicle 10 can further include a source of motive power 20, which can be an internal combustion engine, an electric motor or any other suitable source of motive power. The source of motive power 20 can be drivingly connected to a drivetrain (not shown) that is operable for transferring torque to the front wheels 14 and/or the rear wheels 16. Vehicle 10 can also include a body 26 that can be supported by frame 18, a seat 28 that is suitable for supporting an operator of vehicle 10, and a handlebar assembly 30 configured for turning the front wheels 14 to steer vehicle 10.

The front wheels 14 can be suspended from frame 18 using a front suspension. The front suspension can include a left front suspension 40 and a right front suspension (not shown). The left front suspension 40 can include a left front upper control arm 42 and a left front lower control arm 44. Each of the control arms 42 and 44 can be pivotally coupled to frame 18. Although the control arms 42 and 44 are shown to be of the type having an A-arm configuration, it will be appreciated that control arms can be provided in any of a variety of suitable alternative configurations (e.g., L-shaped). As shown in FIG. 2, the left front upper control arm 42 can include a pair of inner ends 42a and each of the inner ends 42a can be pivotally coupled to frame 18, for example using pins as shown. An outer end 42b of the left front upper control arm 42 and an outer end (not shown) of the left front lower control arm 44 can pivotally support a left front steering knuckle 46. A left front tie rod 48 can connect the left front steering knuckle 46 and a steering gear assembly (not shown), that is coupled to the handlebar assembly 30. The left front suspension 40 can include a cushion 45, which can be a shock, strut or other suitable component, that is connected at one end to frame 18 and is connected at the opposite end to the left front upper control arm 42.

A left front rotatable shaft 50 can be journalled within the left front steering knuckle 46 and can be rotatably coupled, for example with splines, to a left front wheel hub 52. The left front rotatable shaft 50 can extend laterally outwardly from the left front wheel hub 52. A plurality of lug studs 54 can be fixed to the left front wheel hub 52 and can extend laterally outwardly from the left front wheel hub 52. The left front wheel 14 can be mounted on the left front wheel hub 52 with the plurality of lug studs 54 and a plurality of lug nuts 56, with each of the lug nuts 56 being secured to a respective one of the lug studs 54. Alternatively, a wheel hub can be provided that includes a plurality of internally threaded apertures that each receives a male fastener, for example a bolt, that extends through a rim of the left front wheel 14. Vehicle 10 can include a right front rotatable shaft (not shown) and the right front suspension (not shown) can be configured similar to the left front suspension 40 and is associated with the right front rotatable shaft and a right one (not shown) of the front wheels 14.

Vehicle 10 can also include a rear suspension that can include a left rear suspension 70 and a right rear suspension (not shown). The left rear suspension 70 can include a left rear upper control arm 72 and a left rear lower control arm 74. Each of the control arms 72 and 74 can be pivotally coupled to frame 18. Although the control arms 72 and 74 are shown to be of the type having an A-arm configuration, it will be appreciated that control arms can be provided in any of a variety of suitable alternative configurations (for example, L-shaped). As shown in FIG. 2, the left rear upper control arm 72 can include a pair of inner ends 72a and each of the inner ends 72a can be pivotally coupled to frame 18, for example using pins as shown. An outer end (not shown) of the left rear upper control arm 72 and an outer end (not shown) of the left rear lower control arm 74 can pivotally support a left rear knuckle (not shown). The left rear suspension 70 can include a cushion 75, which can be a shock, strut or other suitable component, that is connected at one end to frame 18 and is connected at the opposite end to the left rear upper control arm 72.

A left rear rotatable shaft 80 can be journalled within the left rear knuckle and can be rotatably coupled, for example with splines, to a left rear wheel hub 82. The left rear rotatable shaft 80 can extend laterally outwardly from the left rear wheel hub 82. An inner end of the left rear rotatable shaft 80 can be rotatably coupled to a drivetrain component (not shown), which can be a differential. The inner end of the left rear rotatable shaft 80 can be coupled to the drivetrain component via a constant velocity (CV) joint. A plurality of lug studs 84 can be fixed to the left rear wheel hub 82 and can extend laterally outwardly from the left rear wheel hub 82. The left rear wheel 16 can be mounted on the left rear wheel hub 82 with the plurality of lug studs 84 and a plurality of lug nuts 86 with each of the lug nuts 86 being secured to a respective one of the lug studs 84. Alternatively, a wheel hub can be provided that includes a plurality of internally threaded apertures that each receives a male fastener, for example a bolt, that extends through a rim of the left rear wheel 16. Vehicle 10 can include a right rear rotatable shaft (not shown) and the right rear suspension (not shown) can be configured similar to the left rear suspension 70 and is associated with the right rear rotatable shaft and a right one (not shown) of the rear wheels 16.

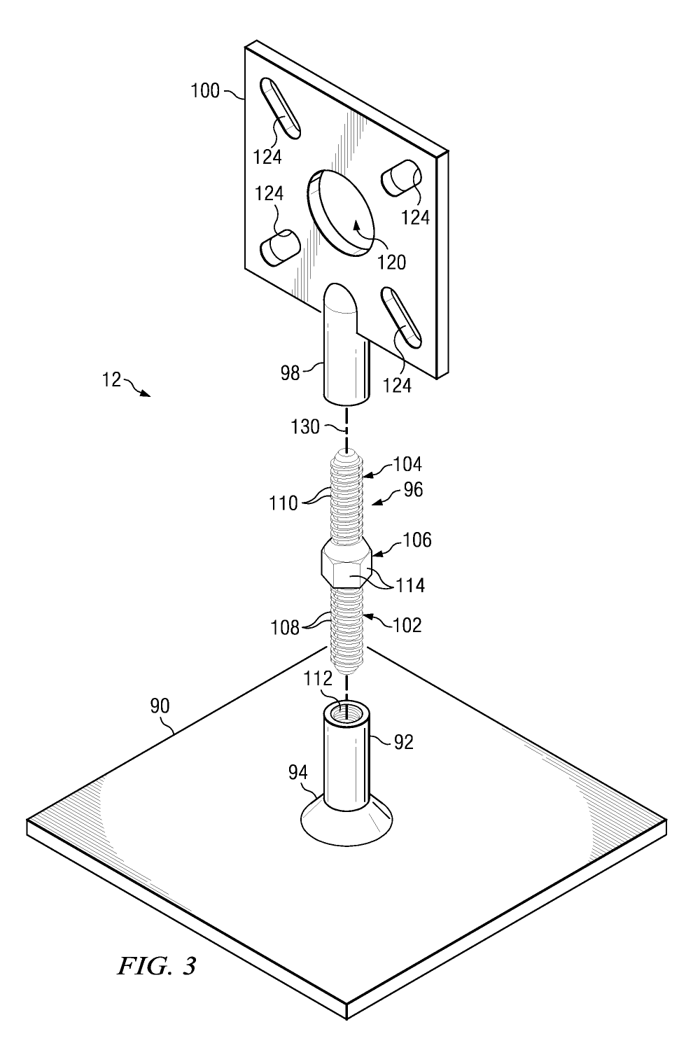

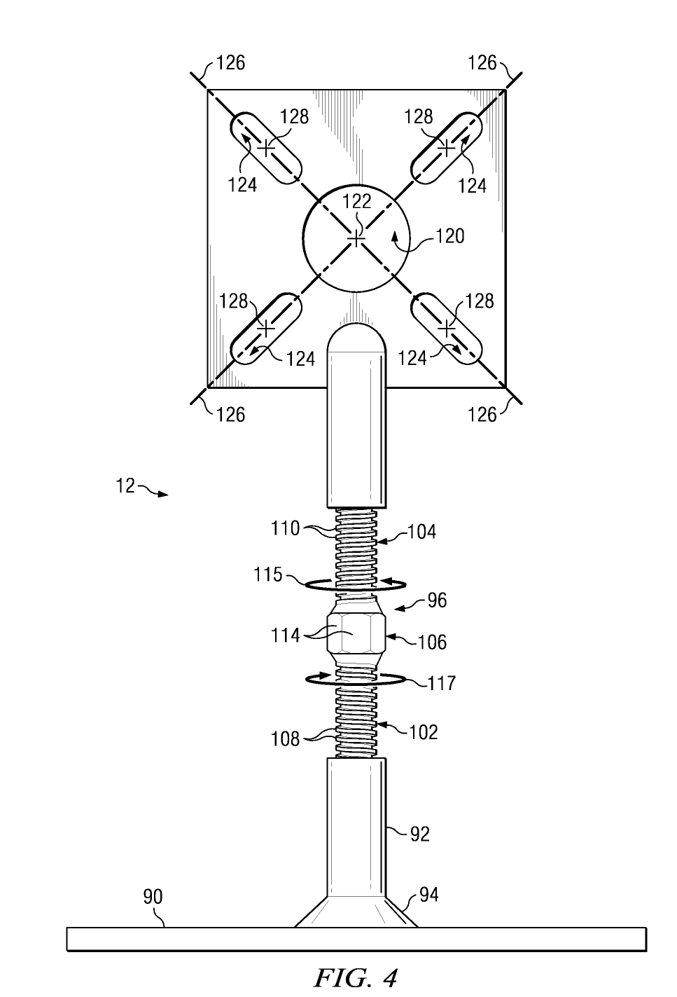

As shown in FIGS. 3 and 4, the adjustable vehicle support stand 12 can include a base 90, which can be a plate or any other suitable structure, and a lower collar 92 that can be secured to the base 90. As shown in FIGS. 3 and 4, the lower collar 92 can be indirectly secured to the base 90 using a mount member 94, i.e., a lower end of the lower collar 92 can be secured to the mount member 94, for example by welding, which in turn can be secured to the base 90, for example by welding. Alternatively, collars can be provided that are directly secured to a base.

The adjustable vehicle support stand 12 can further include a rod 96, an upper collar 98 and a plate 100 secured to the upper collar 98 and extending upwardly from the upper collar 98. Rod 96 can be threadably engaged with each of the lower collar 92 and the upper collar 98. Rod 96 can include a lower portion 102, an upper portion 104 and a torquing portion 106 that separates the lower portion 102 and the upper portion 104. The lower portion 102 and the upper portion 104 of the rod 96 can include opposite external threads. As shown in FIGS. 3 and 4, the lower portion 102 of rod 96 can include a plurality of left-hand external threads 108 and the upper portion 104 of rod 96 can include a plurality of right-hand external threads 110. Alternatively, rods can be provided having a lower portion with a plurality of right-hand external threads and an upper portion with a plurality of left-hand external threads. The lower portion 102 of rod 96 can be threadably engaged with the lower collar 92, such that the left-hand external threads 108 of the lower portion 102 engage mating internal threads 112 (FIG. 3) of the lower collar 92. The upper portion 104 of rod 96 can be threadably engaged with the upper collar 98, such that the right-hand external threads 110 of the upper portion 104 engage mating internal threads (not shown) of the upper collar 98. The torquing portion 106 of rod 96 can be configured to facilitate the application of torque to the rod 96 to rotate the rod 96. For example, as shown in FIGS. 3 and 4, the torquing portion 106 of rod 96 can include a plurality of flats 114 that can engage a suitable tool such as a wrench. Torque can be applied to rod 96 to rotate rod 96 in a direction indicated by arrow 115 in FIG. 3, or in an opposite direction indicated by arrow 117 in FIG. 3.

The plate 100 is vertically movable relative to the base 90 in response to rotation of the rod 96. More particularly, the plate 100 can move upwardly or downwardly relative to the base 90, depending upon the direction of rotation of rod 96. The vertical movement of plate 100 relative to base 90 can be achieved due to the use of the opposite hand external threads of the lower portion 102 of rod 96 and the upper portion 104 of rod 96.

The plate 100 can be configured for attachment to a wheel hub of a vehicle, for example, to any one of the left front wheel hub 52, the left rear wheel hub 82, and the right front and right rear wheel hubs (not shown) of vehicle 10. As shown in FIGS. 3 and 4, plate 100 can include an aperture 120 that can have a generally circular shape. Aperture 120 can include a center 122 (FIG. 4). The aperture 122 is configured to receive a rotatable shaft of a vehicle. For example, the aperture 120 can be configured to receive the left front rotatable shaft 50 or the left rear rotatable shaft 80, when the plate 100 is mounted to the left front wheel hub 52 or the left rear wheel hub 82, respectively. The aperture 120 can be sized such that there is an annular clearance between the aperture 120 and the respective rotatable shaft extending through aperture 120, as shown in FIG. 2. In other embodiments, a plate can be provided that does not include a generally circular aperture, such as aperture 120, for use with vehicles that do not include a rotatable shaft extending outwardly from the wheel hub to which the plate is mounted.

Plate 100 can also include a plurality of apertures 124, with each of the apertures 124 being configured to receive a male fastener, such as one of the lug studs 54 or one of the lug studs 84. Each of the apertures 124 can be elongated. The apertures 124 can be located radially outwardly from the aperture 120 and can be circumferentially spaced from one another. The apertures 124 can be equally spaced from one another. As shown in FIGS. 3 and 4, each of the apertures 124 can be generally oval-shaped and accordingly, can advantageously accommodate male fasteners such as lug studs 54 or lug studs 84 that are positioned on circles having various diameters. Each of the apertures 124 can include a major axis 126 and a center 128 positioned on the major axis 126. The major axis 126 of each of the apertures 124 can intersect the center 122 of the aperture 120, and the centers 128 of the apertures 124 can be equidistant from the center 122 of the aperture 120. The rod 96 includes a longitudinal axis 130 that can intersect the center 122 of the aperture 120.

As shown in FIGS. 3 and 4, the plate 100 can include four of the apertures 124. However, plates can be provided having different numbers of apertures having elongated shapes and/or apertures having different configurations, as compared to the apertures 124. For example, a plurality of circumferentially and equally spaced apertures having “over-sized” diameters, i.e., substantially larger than the diameter of lug studs to be received, can be provided. As another example, a plurality of radially spaced apertures can be used in lieu of each aperture 124, to accommodate lug studs positioned on circles having various diameters.

One or more of the adjustable vehicle support stands 12 can be used to partially or completely support vehicle 10 in lieu of front wheels 14 and rear wheels 16, and to facilitate measuring various features of the front suspension 40 and/or the rear suspension 70. Each of the front wheels 14 and each of the rear wheels 16 can be removed, with the vehicle 10 being suitably supported during this process, and a plurality of the adjustable vehicle support stands 12 can be mounted to respective wheel hubs such that the adjustable vehicle support stands 12 support vehicle 10 instead of the front wheels 14 and rear wheels 16. For example, a first one of the adjustable vehicle support stands 12 can be mounted to the left front wheel hub 52, a second stand 12 can be mounted to the right front wheel hub (not shown), a third one of the stands 1 2 can be mounted to the left rear wheel hub 82 and a fourth one of the stands 12 can be mounted to the left rear wheel hub (not shown).

The manner in which the adjustable vehicle support stands 12 can be mounted to the respective wheel hub can be illustrated with respect to the adjustable vehicle support stand 12 that can be mounted to the left rear wheel hub 82. The adjustable vehicle support stand 12 can be positioned such that the left rear rotatable shaft 80 extends through the aperture 120 and each of the lug studs 84 extend through a respective one of the apertures 124. Plate 100 can then be secured in place using lug nuts 86, with each lug nut 86 secured to a respective one of the lug studs 84. The vertical height of plate 100 can be adjusted as required by applying torque to the torquing portion 106 of rod 96 to rotate rod 96 and move plate 100 upwardly or downwardly, such that the left rear rotatable shaft 80 is positioned at a desired predetermined vertical distance from a support surface, such as support surface 140 shown in FIG. 2, so that the desired measurements of the left rear suspension 70 can be made. Additional measurements of the left rear suspension 70 can be obtained by rotating rod 96 to position the rotatable shaft 80 at the required predetermined vertical distance from support surface 140, for each additional measurement, or set of measurements, of the left rear suspension 70.

The pitch of the external threads 108, 1 10 of the lower portion 102 and upper portion 104 of rod 96, respectively, and the mating internal threads of the lower collar 92 and the upper collar 98, respectively, can be selected to achieve the desired response of plate 100 to the application of torque to the torquing portion 106 of rod 96. The elongated apertures 124 can advantageously accommodate male fasteners such as lug studs 54 or lug studs 84, which enhances the versatility of the adjustable vehicle support stand 12. Plate 100 allows easy access to the left rear knuckle (not shown), and accordingly facilitates measurement of the left rear suspension 70. Additionally, use of the adjustable vehicle support stands 12 avoids undesirable changes in height of the respective rotatable shafts, due to a change in the internal pressure of vehicle tires, which can occur during some conventional procedures used to measure vehicle suspensions.

While the inventive principles have been illustrated by the description of various embodiments thereof, and while the embodiments have been described in considerable detail, it is not intended to restrict or in any way limit the scope of the appended claims to such detail. Additional advantages and modifications will be readily apparent to those skilled in the art. The invention in its broader aspects is therefore not limited to the specific details, representative apparatus, methods and examples shown and described. Accordingly, departures may be made from such details without departing from the scope or spirit of the general inventive principles.

1. An adjustable vehicle support stand, comprising:
a base;
a lower collar secured to the base;
a rod threadably engaged with the lower collar;
an upper collar threadably engaged with the rod; and
a plate secured to the upper collar and extending upwardly from the upper collar, the plate being configured for attachment to a wheel hub of a vehicle; wherein
the rod comprises a lower portion, an upper portion and a torquing portion separating the lower portion and the upper portion, the torquing portion being configured to facilitate rotation of the rod;
the lower portion of the rod is threadably engaged with the lower collar and the upper portion of the rod is threadably engaged with the upper collar;
one of the lower portion of the rod and the upper portion of the rod comprises a plurality of left-hand external threads, the other of the lower portion of the rod and the upper portion of the rod comprising a plurality of right-hand external threads; and
the plate is vertically movable relative to the base in response to rotation of the rod.

2. The adjustable vehicle support stand of claim 1, wherein:
the plate defines a first aperture configured to receive a rotatable shaft of a vehicle and further defines a plurality of second apertures, each of the second apertures being configured to receive a male fastener, each of the second apertures being located outwardly from the first aperture and spaced from one another.

3. The adjustable vehicle support stand of claim 2, wherein:
the first aperture has a generally circular shape and has a first center; and
each of the second apertures is generally oval-shaped and comprises a major axis and a second center positioned on the major axis, each of the second centers being equidistant from the first center.

4. The adjustable vehicle support stand of claim 1, wherein:
the plate defines a plurality of apertures, each of the apertures being elongated and configured to receive a male fastener, the elongated apertures being equally spaced from one another.

5. The adjustable vehicle support stand of claim 1, wherein:
the torquing portion of the rod comprises a plurality of flats configured to receive a torque-application tool.

6. The adjustable vehicle support stand of claim 1, wherein:
the base comprises a plate.

7. The adjustable vehicle support stand of claim 1, further comprising:
a mount member secured to the base, wherein the lower collar is secured to the mount member.

8. The adjustable vehicle support stand of claim 3, wherein:
the major axis of each of the second apertures intersects the center of the first aperture.

9. The adjustable vehicle support stand of claim 8, wherein:
the rod comprises a longitudinal axis that intersects the center of the first aperture.

10. A method of vertically positioning a vehicle to measure a suspension of the vehicle, the vehicle comprising at least one rotatable wheel hub, the method comprising:
providing an adjustable vehicle support stand, the stand comprising a base, a lower collar secured to the base, and a rod, the rod having a lower portion, an upper portion and a torquing portion separating the lower portion and the upper portion, the stand further comprising an upper collar and a plate secured to the upper collar, the lower portion of the rod being threadably engaged with the lower collar, the upper portion of the rod being threadably engaged with the upper collar;
positioning the base on a support surface;
mounting the plate on the wheel hub; and
rotating the rod so that the plate and the wheel hub move vertically relative to the base and the wheel hub is spaced from the support surface by a predetermined vertical distance.

11. The method of claim 10, wherein the vehicle comprises a plurality of the wheel hubs, the method further comprising:
providing a plurality of adjustable vehicle support stands;
positioning the base of each of the adjustable vehicle support stands on the support surface;
mounting the plate of each of the adjustable vehicle support stands on a respective wheel hub; and
rotating the rod of each of the adjustable vehicle support stands so that the respective plate and the respective wheel hub move vertically relative to the respective base and each respective wheel hub is spaced from the support surface by a respective predetermined vertical distance.

12. The method of claim 10, wherein the plate defines a plurality of equally spaced elongated apertures and wherein mounting the plate on the wheel hub comprises:
positioning the plate so that each one of a plurality of lug studs secured to and extending laterally outwardly from the wheel hub extends through a respective one of the elongated apertures.

13. The method of claim 12, wherein the plate further defines a generally circularly shaped aperture, each of the elongated apertures being located outwardly from the generally circularly shaped aperture and spaced from one another, and wherein mounting the plate on the wheel hub further comprises:
positioning the plate so that a rotatable shaft, which is secured to and extends laterally outwardly from the wheel hub, extends through the generally circularly shaped aperture.

14. The method of claim 13, wherein one of the lower portion and the upper portion of the rod includes a plurality of left-hand external threads and the other of the lower portion of the rod and the upper portion of the rod includes a plurality of right-hand external threads, and wherein rotating the rod comprises:
applying torque to the torquing portion of the rod.

15. An adjustable vehicle support stand, comprising:
a base;
a rod supported by the base; and
a plate coupled to the rod opposite the base, the plate being configured for attachment to a wheel hub of a vehicle, wherein the plate defines a first aperture configured to receive a rotatable shaft of the vehicle and further defines a plurality of second apertures, each of the second apertures being configured to receive a male fastener, each of the second apertures being located outwardly from the first aperture, the second apertures being spaced from one another; wherein
the plate is vertically movable relative to the base in response to rotation of the rod.

16. The adjustable vehicle support stand of claim 15, wherein:
the first aperture has a generally circular shape and has a first center; and
each of the second apertures is generally oval-shaped and comprises a major axis and a second center positioned on the major axis, each of the second centers being equidistant from the first center.

17. The adjustable vehicle support stand of claim 16, wherein the major axis of each of the second apertures intersects the first center of the first aperture.

18. The adjustable vehicle support stand of claim 15, wherein each of the second apertures is elongated.

19. The adjustable vehicle support stand of claim 15, wherein the rod comprises a threaded lower portion, a threaded upper portion and a torquing portion separating the lower portion and the upper portion, the torquing portion being configured to facilitate rotation of the rod.

20. The adjustable vehicle support stand of claim 15, further comprising an upper collar secured to the plate for engagement with the rod.
